(19) United States
(12) Patent Application Publication
(10) Pub. No.: US 2023/0286051 A1
(43) Pub. Date: Sep. 14, 2023

(54) METHOD OF SETTING FABRICATION CONDITION, ADDITIVE FABRICATION METHOD, ADDITIVE FABRICATION SYSTEM, AND PROGRAM

(71) Applicant: Kabushiki Kaisha Kobe Seiko Sho (Kobe Steel, Ltd.), Kobe-shi (JP)

(72) Inventors: Naoki MUKAI, Fujisawa-shi (JP); Shun IZUTANI, Fujisawa-shi (JP)

(73) Assignee: Kabushiki Kaisha Kobe Seiko Sho (Kobe Steel, Ltd.), Kobe-shi (JP)

(21) Appl. No.: 18/005,899

(22) PCT Filed: Aug. 25, 2021
(86) PCT No.: PCT/JP2021/031259

§ 371 Date: Jan. 18, 2023

(30) Foreign Application Priority Data
Sep. 25, 2020 (JP) 2020-161261

(51) Int. Cl. B22F 10/85; B22F 10/22; B22F 10/36

(52) U.S. Cl. CPC B22F 10/85; B22F 10/22; B22F 10/36; B23K 9/032

(57) ABSTRACT

A method for setting a fabrication condition for performing additive fabrication of an object on the basis of fabrication shape data of the object, the method including: a dividing step for dividing a shape indicated by the fabrication shape data into elements of a predetermined unit size; a partitioning step for partitioning, with respect to each of a plurality of cross sectional shapes in a fabrication direction, the elements constituting the cross sectional shape according to prescribed position type; and a setting step for setting, with respect to each of regions partitioned in the partitioning step, the fabrication condition from among additive patterns defined corresponding to the position type.

### TECHNICAL FIELD

The present invention relates to a method of setting a fabrication condition, an additive fabrication method, an additive fabrication system, and a program.

### BACKGROUND ART

In recent years, there has been an increasing need to manufacture components by using 3D printer fabrication, and fabrication with a metal material has been researched and developed for practical use. Many 3D printers for the fabrication with the metal material fabricates an additive fabrication object by stacking weld metal that is formed by melting and solidifying metal powder or a metal wire by using a heat source such as a laser, an electron beam, or an electric arc.

In PTL 1, which is the related art, when an additive fabrication object is fabricated, a fabrication shape is sliced into certain unit height, and a fabrication condition is set per unit height.

### CITATION LIST

### Patent Literature

PTL 1: Japanese Unexamined Patent Application Publication No. 2019-198886

### SUMMARY OF INVENTION

### Technical Problem

In some cases, a failure such as a lack of fusion or burning through occurs depending on situations when the additive fabrication object is fabricated. For example, in some cases where a route when the additive fabrication object is fabricated has a corner portion, the failure of the lack of fusion occurs when the corner portion is formed in the same deposition condition as the other portion. If the efficiency of the fabrication is emphasized, and thermal energy is increased, there is a possibility that an edge portion of the additive fabrication object is burned through. In contrast, if prevention of burning through is emphasized more than necessary, the efficiency of the fabrication decreases. In a method in PTL 1, the fabrication condition is set per layer, and accordingly, the fabrication condition is not controlled in consideration of a position at which a welding failure is likely to occur and a position at which the efficiency is emphasized. That is, the existing method has a room for improvement to increase the efficiency of the fabrication and to inhibit a welding failure from occurring.

In view of the problems described above, it is an object of the present invention to increase the efficiency of additive fabrication and to inhibit a welding failure from occurring.

### Solution to Problem

To solve the problems described above, the present invention has a feature described below.

(1) A method of setting a fabrication condition for performing additive fabrication of an object, based on fabrication shape data of the object includes a dividing step of dividing a shape that is indicated by using the fabrication shape data into elements that have a predetermined unit size, a sorting step of sorting the elements that form sectional shapes according to a predetermined position type as for the multiple sectional shapes in an additive direction, and a setting step of setting the fabrication condition from an additive pattern that is defined according to the position type as for regions that are sorted at the sorting step.

Another aspect of the present invention has a feature described below.

(2) An additive fabrication method of performing additive fabrication of an object, based on fabrication shape data of the object includes a dividing step of dividing a shape that is indicated by using the fabrication shape data into elements that have a predetermined unit size, a sorting step of sorting the elements that form sectional shapes according to a predetermined position type as for the multiple sectional shapes in an additive direction, a setting step of setting a fabrication condition from an additive pattern that is defined according to the position type as for regions that are sorted at the sorting step, and a control step of causing a fabrication means to perform the additive fabrication of the object, based on the fabrication condition that is set at the setting step.

Another aspect of the present invention has a feature described below.

(3) An additive fabrication system that performs additive fabrication of an object, based on fabrication shape data of the object includes an acquiring means that acquires the fabrication shape data, a storage means that associates a shape of an element that is included in the object and an additive pattern for fabricating the element with each other and that holds the shape and the additive pattern, a dividing means that divides a shape that is indicated by using the fabrication shape data into elements that have a predetermined unit size, a sorting means that sorts the elements that form sectional shapes according to a predetermined position type as for the multiple sectional shapes in an additive direction, a setting means that sets a fabrication condition from the additive pattern that is defined according to the position type as for regions that are sorted by the sorting means, and a fabrication means that performs the additive fabrication of the object, based on the fabrication condition that is set by the setting means.

Another aspect of the present invention has a feature described below.

(4) A program causes a computer to execute a dividing step of dividing a shape that is indicated by using fabrication shape data of an object into elements that have a predetermined unit size, a sorting step of sorting the elements that form sectional shapes according to a predetermined position type as for the multiple sectional shapes in an additive direction, and a setting step of setting a fabrication condition for performing additive fabrication of the object from an additive pattern that is defined according to the position type as for regions that are sorted at the sorting step.

### Advantageous Effects of Invention

The present invention enables the efficiency of additive fabrication to be increased and enables a welding failure to be inhibited from occurring.

### BRIEF DESCRIPTION OF DRAWINGS

FIG. 1 schematically illustrates an example of the entire structure of a system according to a first embodiment of the present invention.

FIG. 2 is a block diagram of an example of the functional configuration of a fabrication control device according to the first embodiment of the present invention.

FIG. 3 schematically illustrates an example of the structure of a deposition condition DB according to the first embodiment of the present invention.

FIG. 4 is a schematic diagram for describing the flow of classifying a position type according to the first embodiment of the present invention.

FIG. 5 is a flowchart of processing according to the first embodiment of the present invention.

FIG. 6 is a block diagram of an example of the functional configuration of a fabrication control device according to a second embodiment of the present invention.

FIG. 7 schematically illustrates an example of the structure of a deposition condition DB according to the second embodiment of the present invention.

FIG. 8 is a schematic diagram for describing the flow of classifying the position type according to the second embodiment of the present invention.

FIG. 9 is a schematic diagram for describing an example of the position type according to the second embodiment of the present invention.

FIG. 10 is a flowchart of processing according to the second embodiment of the present invention.

### DESCRIPTION OF EMBODIMENTS

Embodiments for carrying out the present invention will hereinafter be described with reference to the drawings. The embodiments described below are embodiments for describing the present invention, and it is not intended that the present invention is restrictively interpreted. All of features described according to the embodiments are not necessarily essential to solve the problems for the present invention. In the drawings, like components are designated by using like reference signs to represent a correspondence.

### First Embodiment

A first embodiment of the present invention will now be described.

[System Configuration]

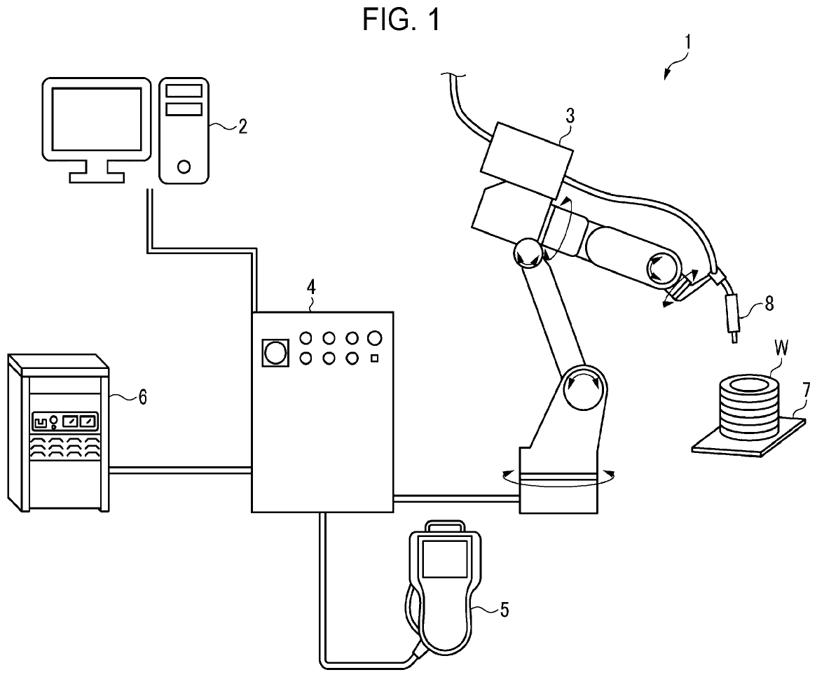

An embodiment of the present invention will now be described in detail with reference to the drawings. FIG. 1 schematically illustrates an example of the entire structure of an additive fabrication system for which an additive fabrication method according to the present invention can be used.

An additive fabrication system 1 according to the present embodiment includes a fabrication control device 2, a manipulator 3, a manipulator control device 4, a controller 5, and a heat source control device 6.

The manipulator control device 4 controls the manipulator 3, the heat source control device 6, and a filler-metal-supplying unit that supplies filler metal (also referred to below as a wire) to the manipulator 3 and that is not illustrated. The controller 5 is a component for inputting an instruction of an operator of the additive fabrication system 1 and can input a freely selected operation to the manipulator control device 4.

An example of the manipulator 3 is an articulated robot and is held such that the wire can be continuously supplied to a torch 8 that is disposed on an end shaft. The torch 8 holds the wire such that the wire protrudes from an end. The position and posture of the torch 8 can be freely set three-dimensionally within the range of the degree of freedom of a robot arm that is included in the manipulator 3. The manipulator 3 preferably has the degree of freedom of 6 or more axes and is preferably capable of freely changing the axial direction of a heat source at the end. In an example in FIG. 1, as illustrated by using arrows, the manipulator 3 has the degree of freedom of 6 axes. The form of the manipulator 3 may be an articulated robot that has 4 or more axes or a robot that includes angle adjustment mechanisms on 2 or more orthogonal axes.

The torch 8 includes a shield nozzle not illustrated, and shield gas is supplied from the shield nozzle. The shield gas shields the atmosphere, prevents oxidation and nitridization of melted metal during welding, and inhibits a welding failure from occurring. An arc welding method used according to the present embodiment may be a consumable electrode method such as shield arc welding or carbon dioxide gas arc welding or a non-consumable electrode method such as TIG (Tungsten Inert Gas) welding or plasma arc welding and is appropriately selected depending on an additive fabrication object to be fabricated. In the description according to the present embodiment, gas metal arc welding is taken as an example.

As for the manipulator 3, in the case where the consumable electrode method is the arc welding method, a contact chip is disposed in the shield nozzle, and the contact chip holds the wire to which an electric current is transmitted. The torch 8 holds the wire and generates an arc from an end of the wire in a shield gas atmosphere. An unwinding mechanism that is mounted on, for example, the robot arm and that is not illustrated feeds the wire from the filler-metal-supplying unit, not illustrated, to the torch 8. The torch 8 is moved, the wire that is continuously fed is melted and solidified, and consequently, a linear bead that has a body acquired by melting and solidifying the wire is formed on a base 7. The beads are stacked, and a target additive fabrication object W is fabricated.

The heat source that melts the wire is not limited to the arc described above. For example, the heat source may use a heating method by using the arc and the laser, a heating method by using the plasma, a heating method by using the electron beam or the laser, or another method. In the case where the electron beam or the laser is used for heating, the amount of heat can be more finely controlled, the state of each bead can be appropriately maintained, and the quality of an additive structure can be improved. The material of the wire is not particularly limited. The kind of the used wire may be changed depending on the characteristics of the additive fabrication object W, and examples thereof include mild steel, high tensile strength steel, aluminum, aluminum alloy, nickel, and nickel-based alloy.

The manipulator control device 4 drives the manipulator 3 and the heat source control device 6, based on a predetermined program group that is provided from the fabrication control device 2 and causes the additive fabrication object W to be fabricated on the base 7. That is, the manipulator 3 moves the torch 8 in response to an instruction from the manipulator control device 4 while the wire is melted by using the arc. The heat source control device 6 is a welding power supply that supplies power required for welding by using the manipulator 3. The heat source control device 6 can change the electric current and the voltage when each bead is formed. According to the present embodiment, the base 7 has a flat structure but is not limited thereto. For example, the base 7 may have a column shape, and the bead may be formed on the outer circumferential surface thereof. According to the present embodiment, a coordinate system for fabrication shape data is associated with a coordinate system for the base 7 on which the additive fabrication object W is fabricated. The three axes of each coordinate system may be set such that a three-dimensional position is defined with a freely selected position being the origin. In the case where the base 7 has a column shape, a cylindrical coordinate system may be set, or a spherical coordinate system may be set depending on the case. A coordinate component (also referred to below as a “coordinate axis”) may be freely set depending on the kind of the coordinate system such as a rectangular coordinate system, a cylindrical coordinate system, or a spherical coordinate system. For example, the three axes of the rectangular coordinate system are three straight lines perpendicular to each other in a space and are represented by using an X-axis, a Y-axis, and a Z-axis.

An example of the fabrication control device 2 may be an information-processing apparatus such as a PC (Personal Computer). The functions of the fabrication control device 2 described later may be fulfilled in a manner in which a control unit, not illustrated, reads and runs a program that is stored in a storage device, not illustrated, for the functions according to the present embodiment. Examples of the storage device may include a RAM (Random Access Memory) that has a volatile storage region and a ROM (Read Only Memory) and a HDD (Hard Disk Drive) that have a non-volatile storage region. Examples of the control unit may include a CPU (Central Processing Unit) and a dedicated circuit.

[Functional Configuration]

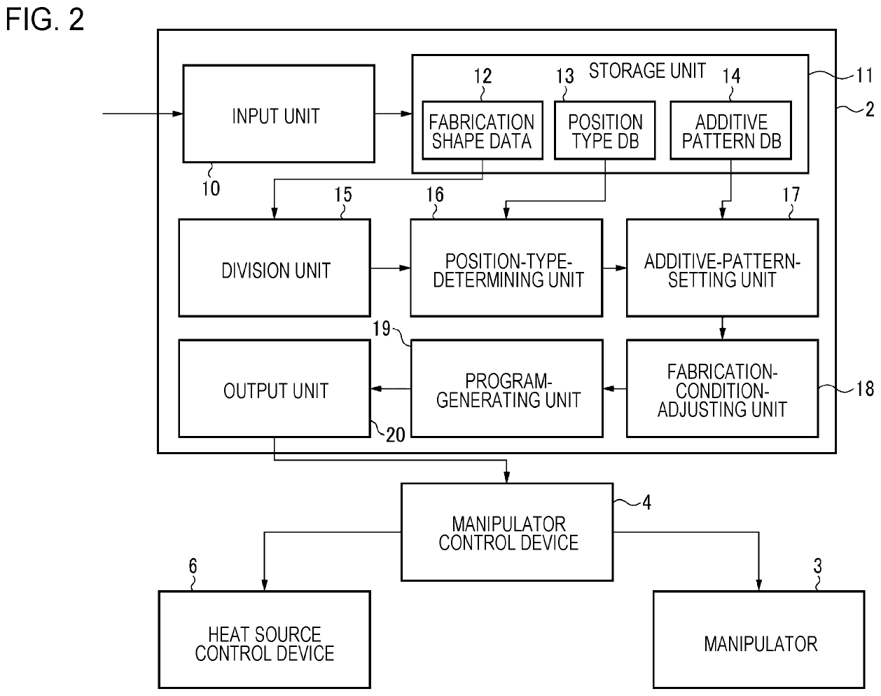

FIG. 2 is a block diagram mainly illustrating the functional configuration of the fabrication control device 2 according to the present embodiment. The fabrication control device 2 includes an input unit 10, a storage unit 11, a division unit 15, a position-type-determining unit 16, an additive-pattern-setting unit 17, a fabrication-condition-adjusting unit 18, a program-generating unit 19, and an output unit 20. For example, the input unit 10 acquires various kinds of information from the outside via a network. An example of the acquired information is the design data (referred to below as the “fabrication shape data”) of the additive fabrication object such as CAD/CAM data. The various kinds of information used according to the present embodiment will be described in detail later. The fabrication shape data may be inputted from an external device that is connected such that the external device can communicate and that is not illustrated or may be produced in the fabrication control device 2 by using predetermined application not illustrated.

The storage unit 11 stores the various kinds of information that the input unit 10 acquires. The storage unit 11 holds and manages a database (DB) for a position type and an additive pattern according to the present embodiment. The position type and the additive pattern will be described in detail later.

The division unit 15 divides the shape of the additive fabrication object that is indicated by using the fabrication shape data into predetermined processing unit size. According to the present embodiment, mesh division and slice division are used as processes of division per processing unit, and the processes will be described in detail later.

The position-type-determining unit 16 refers a position type DB 13 and determines the type of each of multiple elements that are divided by the division unit 15 and that have the unit size depending on a position in the additive fabrication object W.

The additive-pattern-setting unit 17 sets the additive pattern of an element group that is included in the additive fabrication object W, based on an additive pattern DB 14 and the position type that is determined by the position-type-determining unit 16.

The fabrication-condition-adjusting unit 18 adjusts a fabrication condition that includes, for example, a formation route condition and a deposition condition, based on the additive pattern that is set by the additive-pattern-setting unit 17. The formation route condition means a trajectory to the start point of a next pass, the end point and start point of deposition, a route along which a material-supplying device such as the heat source and the torch moves with respect to a reference coordinate, and/or another condition. The deposition condition means a parameter group of a deposition process that is determined by using information about a deposition rate, information about the amount of heat input, and/or information about a heat source direction. For example, in the case where the heat source is the arc, examples of the information about the deposition rate include a wire feed speed and a wire diameter, examples of the information about the amount of heat input include an electric current, a voltage, and a distance between the chip and a base material, and an example of the information about the heat source direction is a torch angle. In the case where the heat source is the laser, examples of the information about the deposition rate include the wire feed speed and the wire diameter, an example of the information about the amount of heat input is a laser output, and examples of the information about the heat source direction include a laser incident angle, the focal length of an optical system, and a relative distance between an object and a focal position. For example, the meanings of the word “adjusting” described herein include an adjustment in the parameters of the deposition condition and determination of the formation order for the beads to predict a thermally deformed shape and to amend the shape. The adjustment in the fabrication condition is not essential but may be omitted.

The program-generating unit 19 generates the program group for fabricating the additive fabrication object W, based on the fabrication condition that is adjusted by the fabrication-condition-adjusting unit 18 as needed. For example, a single program may be associated with a single bead that is included in the additive fabrication object W. The generated program group is processed and run by the manipulator control device 4, and the manipulator 3 and the heat source control device 6 are consequently controlled. The kind and specification of the program group that can be processed by the manipulator control device 4 are not particularly limited. The specification of the wire and the specifications of the heat source control device 6 and the manipulator 3 for generating the program group are acquired in advance.

The output unit 20 outputs the program group that is generated by the program-generating unit 19 to the manipulator control device 4. The output unit 20 may output the result of the processing of components by using an output device such as a display that is included in the fabrication control device 2.

[Database]

According to the present embodiment, as illustrated in FIG. 2, the position type DB 13 and the additive pattern DB 14 are used. The position type DB 13 and the additive pattern DB 14 are defined in advance, held, and managed by the storage unit 11. According to the present embodiment, the additive fabrication object W to be fabricated is divided into multiple elements that have the unit size, and the position type depending on the position in the additive fabrication object W is assigned to each element. As for the position type DB 13, the classification of the position type is defined, and a condition for assigning is specified. Examples of the position type include a flat portion and an inclined portion, but the type is not particularly limited. The condition for assigning the position type may be the position of the element or a relationship in arrangement with respect to an element near the element.

The additive pattern DB 14 is a database that defines, for example, a condition for the additive fabrication with respect to each position type that is defined in the position type DB 13. The additive pattern DB 14 contains at least data that is determined based on formation route information that includes the data of, for example, a torch route and the start and end of deposition, and deposition condition information.

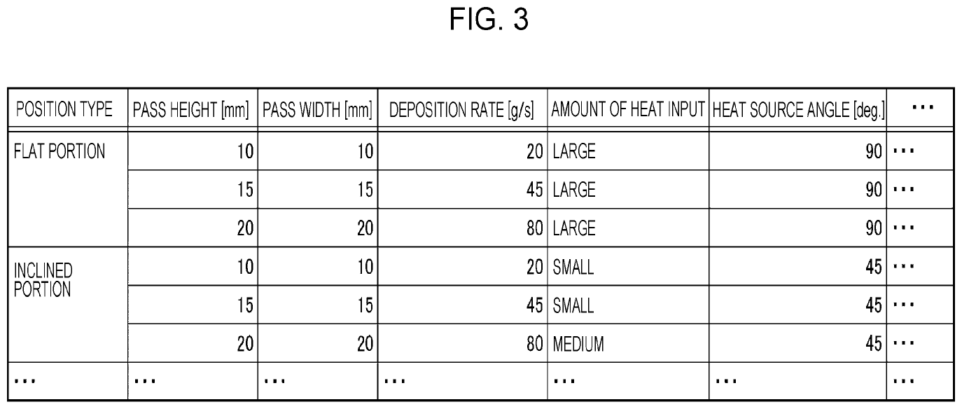

FIG. 3 illustrates an example of the structure of the deposition condition information (also referred to below as a deposition condition DB) that is contained in the additive pattern DB 14 according to the present embodiment. The deposition condition DB contains at least the information about the heat source direction, the information about the amount of heat input, and the information about the deposition rate based on data that indicates a bead shape such as a pass height or a pass width for every position type. General information including the information based on the data that indicates the bead shape, that is, the information about the deposition rate, the information about the amount of heat input, and the information about the heat source direction is referred to as deposition process information. Examples thereof other than the information about the heat source direction, the amount of heat input, and the deposition rate include the temperature of the vicinity, an environmental condition such as a wind speed, the diameter of the nozzle of the torch, and a facility condition such as the characteristics of the heat source control device. Examples of the information about the deposition rate include the wire feed speed, the wire diameter, the distance between the chip and the base material (also referred to below as a wire extension length), and the kind and material of the filler metal.

Examples of the information about the amount of heat input include the electric current, the voltage, and the wire extension length. An example of the information about the heat source direction is the torch angle. In FIG. 3, the deposition rate is illustrated by using the weight of the wire that is melted per unit time but may be, for example, the speed of the feed per unit time, that is, a wire feed speed (m/min). In FIG. 3, the amount of heat input is qualitative data that is illustrated by using the words “large”, “medium” and “small” but may be more finely illustrated by using qualitative evaluation or may be illustrated quantitatively. In a quantitative example, the amount of heat input that is derived from the electric current, the voltage, and the speed and that is used for the field of welding, that is, a value (J/cm) acquired by dividing electric power (electric current A x voltage V=W=J/s) by the speed (cm/min=1/60 cm/s) may be used. In FIG. 3, information about a welding direction is illustrated by using a heat source angle. According to the present embodiment, the heat source angle means an incident angle of a directional heat source, and the angle is formed between a surface on which each bead is formed and the heat source direction in a plane perpendicular to the direction in which the heat source moves. The angle of the heat source can be freely set and does not necessarily match the incident angle of the torch 8. The position type corresponds to a position type that is defined in the position type DB 13. According to the present embodiment, the flat portion and the inclined portion are taken as examples of the position type, but this is not a limitation, and more detailed classification may be used.

The pass height represents the height of the bead per pass when the corresponding position type is formed. The pass width represents the width of the bead per pass when the corresponding position type is formed. The pass height and the pass width correspond to element data that indicates the bead shape as described above. The bead shape is determined by using various conditions related to the deposition rate, the amount of heat input, a heat source method. For this reason, the deposition condition DB is provided such that at least the various conditions related to the deposition rate, the amount of heat input, and the heat source method are included based on at least data of the pass height or the pass width related to the element data that indicates the bead shape. Examples of the element data that indicates the bead shape include a ratio between the pass height and the pass width, a flank angle, and an excessive convexity angle in addition to the pass height and the pass width. According to the present embodiment, at least the pass width or the pass height is preferably used as the element data that indicates the bead shape from the perspective of the ease of setting the additive pattern.

The structure of the deposition condition DB is not limited by items illustrated in FIG. 3 but may include another item. For example, a condition associated with facility information such as the kind of the manipulator 3 and the heat source may be included, and the formation route information that represents the pattern of the formation route of a pass may be collected in the DB.

After the deposition condition is specified, the additive pattern for forming an actual bead can be determined from, for example, the formation route information. Various conditions for fabricating the additive fabrication object W such as the additive pattern and a condition for amending the shape as a whole are also referred to as the fabrication condition.

[Determination of Position Type]

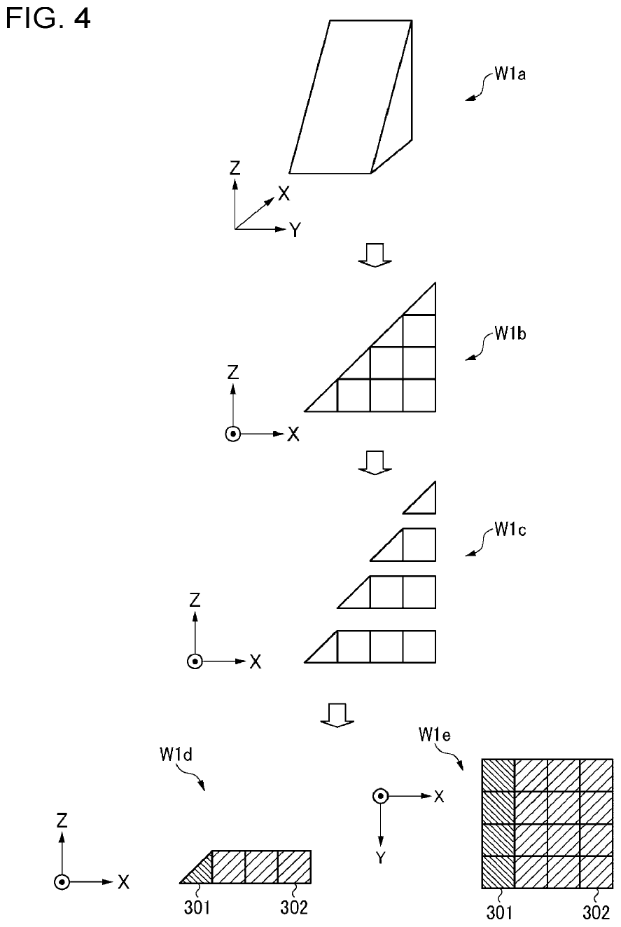

The determination of the position type for the additive fabrication object W according to the present embodiment will be described with reference to FIG. 4. An additive fabrication object W1a that has a three-dimensional shape is used as an example of the additive fabrication object W. In FIG. 4, a three-dimensional space and three axes that represent the three-dimensional space are associated with each other. Coordinate axes are represented by using the X-axis, the Y-axis, and the Z-axis.

The additive fabrication object W1a is first divided into elements that have the unit size. According to the present embodiment, the unit size is that of a cube (referred to below as “mesh”) that has the same length in the directions of the three axes. The division described herein is also referred to as the mesh division. The unit size is not particularly limited but may be defined depending on, for example, precision with which the manipulator 3 can be controlled or size such as the pass height and the pass width when each bead is formed. An additive fabrication object W1b after the mesh division is performed is illustrated.

Subsequently, the additive fabrication object W1b after the mesh division is performed is divided into multiple layers that have a height equal to the height of the mesh. The division into the layers is also referred to below as the slice division, and data of each layer is also referred to as slice data. An additive fabrication object W1c after the additive fabrication object W1b is divided into the multiple layers by the slice division, here, into four layers is illustrated.

Subsequently, attention is paid to the layers after the slice division, and the position type is determined. Additive fabrication objects W1d and W1e are objects when attention is paid to the slice data of the bottom layer of the additive fabrication object W1c. As for the additive fabrication object W1d, the figure is viewed in a Y-axis direction. As for the additive fabrication object W1e, a sectional shape is illustrated in a Z-axis direction. The position type of each element is determined by referring the position type DB 13. Here, the position type of an element group 301 (four elements) is determined to be the inclined portion, and the position type of an element group 302 (12 elements) is determined to be the flat portion. Similarly, the position type of another layer of the additive fabrication object W1c is determined.

In the example described above, the slice division is performed after the mesh division is performed. However, the mesh division may be performed after the slice division is performed. The division that is first performed may be determined depending on, for example, the unit size when the mesh division is performed and relationships among the heights of the layers when the slice division is performed. In the example described above, the height of the unit size during the mesh division is the same as a layer height during the slice division, but this is not a limitation. For example, the layer height when the slice division is performed may be equal to a product of the height of the unit size and an integer.

[Process Flow]

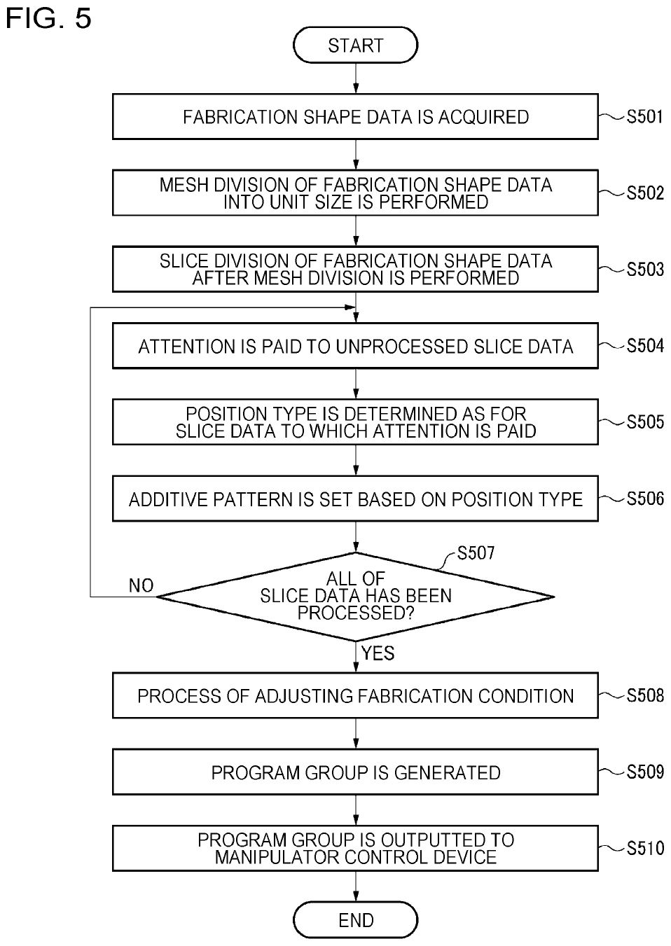

FIG. 5 is a flowchart of processing according to the present embodiment. The processing may be performed, for example, in a manner in which the control unit such as a CPU or a GPU that is included in the fabrication control device 2 reads and runs a program from the storage device, not illustrated, for causing the components illustrated in FIG. 2 to function. In the description herein, a subject that performs the processing is the fabrication control device 2 to make the description easy to understand.

At S501, the fabrication control device 2 acquires the fabrication shape data of the additive fabrication object W to be fabricated. The fabrication shape data may be acquired from the outside or may be produced by using application that is installed in the fabrication control device 2 and that is not illustrated and may be acquired as described above.

At S502, the fabrication control device 2 performs the mesh division of the shape of the additive fabrication object W that is indicated by using the fabrication shape data that is acquired at S501 into the unit size. Here, the unit size is defined in advance and held in, for example, the storage device.

At S503, the fabrication control device 2 divides the fabrication shape data after the mesh division is performed at S502 into multiple layers. The division means the slice division. The layer height that corresponds to a single layer is defined in advance and held in, for example, the storage device. In the description herein, the layer height is the same as the height of the unit size that is used at S502.

At S504, the fabrication control device 2 pays attention to a single piece of the slice data that is unprocessed among multiple pieces of the slice data that are acquired by the slice division at S503. For example, attention may be paid to the unprocessed slice data in order from the slice data of the bottom layer.

At S505, the fabrication control device 2 determines the position type of each element as for the slice data to which attention is paid. A determination method is described above with reference to FIG. 4.

At S506, the fabrication control device 2 sets the additive pattern for each element, based on the additive pattern DB 14 and the position type that is determined at S505. For example, based on the position type and the pass height that matches the layer height of the slice data, the additive pattern DB 14 is referred, and the additive pattern for each element is set. At this time, the additive pattern may be set based on sizes of continuous element groups that have the same position type in a transverse direction (a width direction) and the pass width that is specified by using the additive pattern DB 14. One or multiple routes of passes when a shape that corresponds to the slice data is formed may be set as the additive pattern. A single pass corresponds to a single bead. A single bead includes one or multiple elements during the mesh division.

At S507, the fabrication control device 2 determines whether all of the slice data has been processed. If all of the slice data has been processed (YES at S507), the process of the fabrication control device 2 proceeds to S508. If there is unprocessed slice data (NO at S507), the process of the fabrication control device 2 returns to S504, and the process on the unprocessed slice data is repeated.

At S508, the fabrication control device 2 adjusts the fabrication condition, based on the additive pattern that is set for the slice data. Examples of the adjustment described herein include determination of the formation order for the beads and an adjustment in the deposition condition. As for these, items to be adjusted may be set in consideration of a positional relationship between adjacent beads or the presence or absence of air cutting. A process of adjusting the fabrication condition is not essential but may be omitted.

At S509, the fabrication control device 2 generates the program group that is used by the manipulator control device 4, based on the set additive pattern.

At S510, the fabrication control device 2 outputs the program group that is generated at S509 to the manipulator control device 4. The process flow ends.

According to the present embodiment described above, the additive pattern that includes conditions such as the deposition condition and the formation route can be set depending on the position in the additive fabrication object. For this reason, the efficiency of the additive fabrication can be increased, and a welding failure can be inhibited from occurring.

As for each of the multiple layers that are included in the additive fabrication object, the fabrication condition can be set depending on the position, and accordingly, cutting stock after the additive fabrication object is fabricated can be reduced. For example, an existing method needs to decrease the heights of layers and to increase the number of layers in order to reduce the cutting stock. According to the present embodiment, however, the fabrication condition can be set depending on the position. Accordingly, the number of the layers can be inhibited from increasing, and the efficiency of the fabrication of the entire additive fabrication object can be increased.

### Second Embodiment

A second embodiment of the present invention will be described. The same matters as those according to the first embodiment are omitted, and attention is paid to differences in the description.

[Functional Configuration]

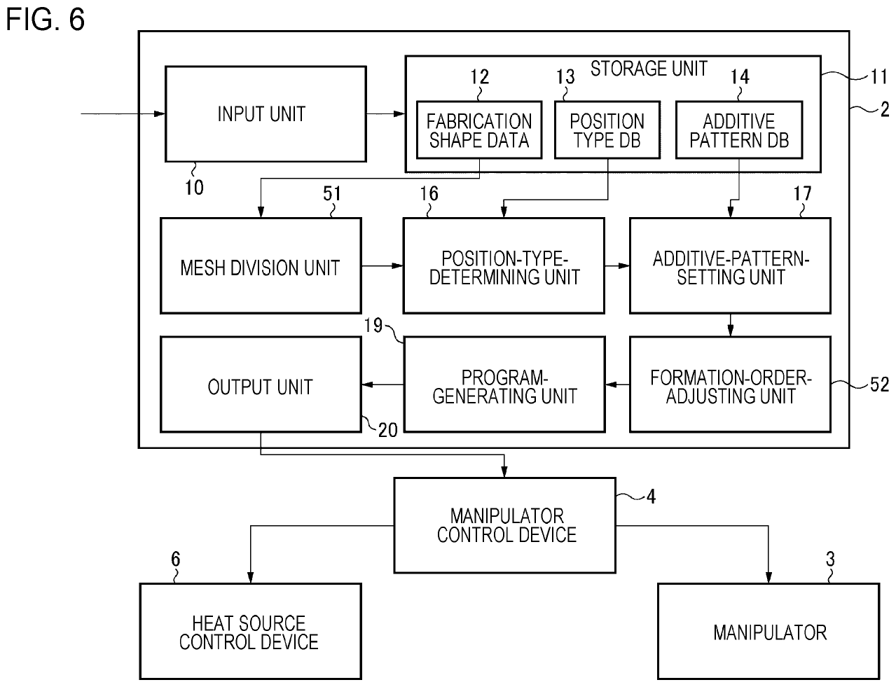

FIG. 6 is a block diagram mainly illustrating the functional configuration of the fabrication control device 2 according to the present embodiment. A difference from FIG. 2 described according to the first embodiment is that a mesh division unit 51 and a formation-order-adjusting unit 52 are included. In addition, the structures of the position type DB 13 and the additive pattern DB 14 are changed. The structures of the DBs will be described later.

The mesh division unit 51 divides the shape of the additive fabrication object that is indicated by using the fabrication shape data into predetermined unit size. According to the first embodiment, the mesh division and the slice division are performed. According to the present embodiment, however, the mesh division is performed. The process will be described in detail later.

The formation-order-adjusting unit 52 adjusts the order in which the multiple beads that are included in the additive fabrication object W are formed, based on the additive pattern that is set by the additive-pattern-setting unit 17. The process will be described in detail later.

[Database]

According to the present embodiment, the position type DB 13 and the additive pattern DB 14 are used as in the first embodiment. The position type DB 13 and the additive pattern DB 14 are defined in advance, held, and managed by the storage unit 11. According to the present embodiment, the mesh division of the additive fabrication object W to be fabricated into multiple elements that have the unit size is performed, and the position type depending on the position in the additive fabrication object W is assigned to each element. As for the position type DB 13, the classification of the position type is defined, and the condition for assigning is specified. Examples of the position type include an outer edge portion, an infill portion, a boundary portion, and a boundary portion corner, but the type is not particularly limited. The boundary portion corresponds to a portion that is located along the boundary between the outer edge portion and the infill portion. The boundary portion corner corresponds to a portion that is located at a corner of the boundary portion. The condition for assigning the position type may be the position of the element or a relationship in arrangement with respect to an element near the element. For example, a surface of the boundary portion may be in contact with the outer edge portion. Two surfaces of the boundary portion corner may be in contact with the outer edge portion.

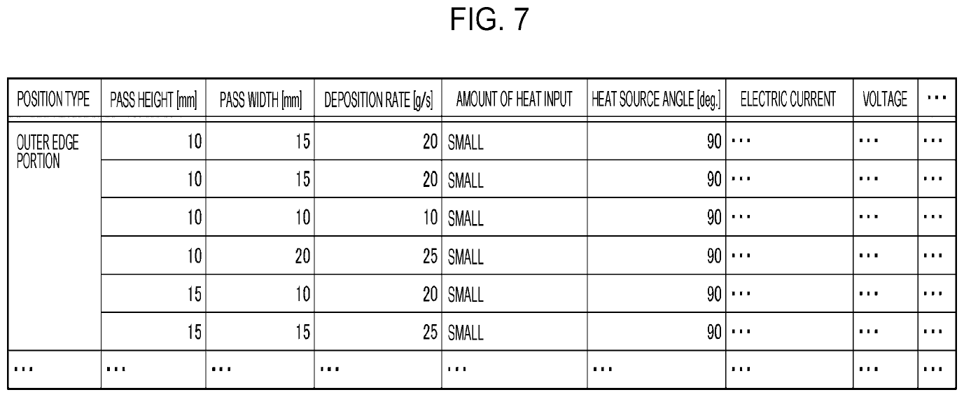

The additive pattern DB 14 is a database that defines, for example, the condition for the additive fabrication with respect to each position type that is defined in the position type DB 13. FIG. 7 illustrates an example of the structure of a deposition condition DB that is contained in the additive pattern DB 14 according to the present embodiment. Examples of the deposition condition DB that is included in the additive pattern DB 14 include the position type, the pass height, the pass width, the deposition rate, the amount of heat input, and the heat source angle. The position type corresponds to a position type that is defined in the position type DB 13. According to the present embodiment, the outer edge portion, an inner charge portion, the boundary portion, and the boundary portion corner are taken as examples of the position type, but this is not a limitation, and more detailed classification may be used.

The pass height represents the height of the bead per pass when the corresponding position type is formed. The pass width represents the width of the bead per pass when the corresponding position type is formed. The deposition rate represents a deposition rate per unit time when the bead is formed. The amount of heat input represents the amount of heat input by using the heat source when the bead is formed. Here, the amount of heat input is represented at three stages of “large”, “medium”, and “small” but may be represented by using a level number or a numeral instead of these. The heat source angle represents the angle of the heat source when the bead is formed. The electric current and the voltage are controlled values of the power supply that is controlled by the heat source control device 6.

For example, the structure of the additive pattern DB 14 may include the formation route information that represents the pattern of the formation route of the pass in addition to the deposition condition DB illustrated in FIG. 3, and the formation route information may be merged with the deposition condition DB into a single DB. After the deposition condition is specified, the additive pattern for forming the actual bead can be determined as described according to the first embodiment.

[Determination of Position Type]

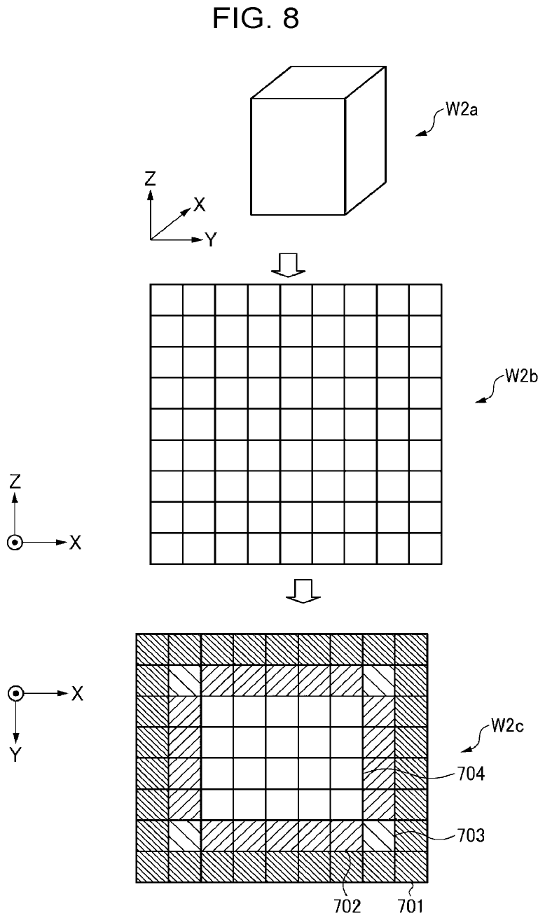

The determination of the position type for the additive fabrication object W according to the present embodiment will be described with reference to FIG. 8. An additive fabrication object W2a that has a three-dimensional shape is used as an example of the additive fabrication object W. In FIG. 8, a three-dimensional space and three axes that represent the three-dimensional space are associated with each other. Coordinate axes are represented by using the X-axis, the Y-axis, and the Z-axis.

The mesh division of the additive fabrication object W2a into elements that have the unit size is first performed. According to the present embodiment, the unit size is that of a cube that has the same length in the directions of the three axes. The unit size is not particularly limited but may be defined depending on, for example, the precision with which the manipulator 3 can be controlled or size such as the pass height and the pass width when each bead is formed. An additive fabrication object W2b after the mesh division is performed is illustrated.

Subsequently, attention is paid to the layers of the additive fabrication object W2b after the mesh division is performed, and the position type is determined. An additive fabrication object W2c is an object when attention is paid to the bottom layer of the additive fabrication object W2b. As for the additive fabrication object W2c, a sectional shape is illustrated in the Z-axis direction. The position type of each element is determined by referring the position type DB 13. Here, the position type of an element group 701 is determined to be the outer edge portion, and 30 elements are included. The position type of an element group 702 is determined to be the boundary portion, and 18 elements are included. The position type of an element group 703 is determined to be the boundary portion corner, and 4 elements are included. The position type of an element group 704 is determined to be the infill portion, and 20 elements are included. Similarly, the position type of another layer of the additive fabrication object W2b is determined. The element group of each layer is sorted depending on the position type.

[Adjustment in Formation Order]

According to the present embodiment, when the additive fabrication object W is fabricated, different fabrication conditions are used depending on the position type in order to increase the efficiency of the additive fabrication and to inhibit a welding failure from occurring. At this time, the pass height and the pass width per pass changes in some cases. In view of this, according to the present embodiment, the formation-order-adjusting unit 52 adjusts the formation order for the beads. A single pass is also referred to as a single bead or one welding length.

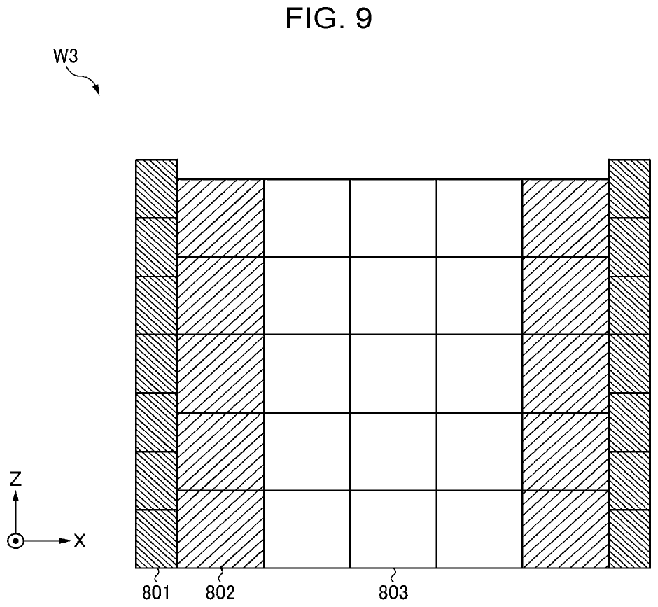

FIG. 9 is a diagram for describing differences in the pass height and the pass width of the single bead depending on the position type. As for the additive fabrication object W3, an example of the result of the fabrication of the additive fabrication object W2a illustrated in FIG. 8 is illustrated as a sectional view in the Y-axis direction. In the example in FIG. 9, the additive fabrication object W3 includes multiple beads that are formed according to the position types of an outer edge portion 801, a boundary portion 802, and an infill portion 803. In the Z-axis direction that coincides with an additive direction, the outer edge portion 801 includes 7 layers (which mean seven stacked beads), the boundary portion includes 5 layers (which mean five stacked beads), and the infill portion 803 include 5 layers (which mean five stacked beads). In an X-axis direction that coincides with the width direction, the outer edge portion 801 is formed along a single pass (a single bead), the boundary portion 802 is formed along a single pass (which means a single bead), and the infill portion 803 is formed along three passes (which mean three stacked beads). The infill portion 803 is illustrated so as to be formed along the three passes for convenience but may be formed along a single pass in each layer. The top layer of the outer edge portion 801 partly protrudes from the shape of the additive fabrication object W. This portion is dealt with as cutting stock to be removed after the fabrication.

In the following description, a relationship between the size of each bead in FIG. 9 and the unit size of the mesh described with reference to FIG. 8 is as follows:
the height of the mesh:the pass height of the outer edge portion:the pass height of the boundary portion:the pass height of the infill portion=2:3:4:4, and
the width of the mesh:the pass width of the outer edge portion:the pass width of the boundary portion:the pass width of the infill portion=1:1:2:2.
   A standard height when the bead of each portion is formed is set based on the relationship. More specifically, in the case where the height of the mesh is 2 mm, the pass height when the outer edge portion is formed is 3 mm, the pass height of the boundary portion is 4 mm, and the pass height of the infill portion is 4 mm. The relationship described above is an example and is not limited thereto.

According to the present embodiment, the additive pattern of each portion that is included in the additive fabrication object W is set based on the position type and the additive pattern DB 14 as described above. As for a setting method at this time, for example, the additive pattern that is suitable for a combination of the pass height that is specified as a standard from the relationship described above and the position type may be set by referring the additive pattern DB 14. Alternatively, the additive pattern that is suitable for a combination of the pass height and the pass width that are specified as standards from the relationship described above and the position type may be set by referring the additive pattern DB 14. Alternatively, the additive pattern that is suitable for a combination of the pass width that is specified as a standard from the relationship described above and the position type may be set by referring the additive pattern DB 14.

After the additive pattern of each portion is set, the formation-order-adjusting unit 52 adjusts the formation order when each bead is formed. A rule for the formation order for the beads can be defined to inhibit a welding failure from occurring. For example, the outer edge portion is first formed in a layer, and subsequently, the infill portion is formed. This inhibits a fall when the bead of the infill portion is formed from occurring. The torch can be inhibited from interfering in a manner in which a difference between the height of the outer edge portion and the height of the infill portion is maintained within a certain range during the additive fabrication. A condition for adjusting the start position and end position of the pass or the route of air cutting may be set to increase the efficiency of the fabrication. The condition described above is defined in advance, and the formation order for the beads is adjusted.

When the formation order for the beads is adjusted, it may be determined that the formation order is to be determined per predetermined unit height in the additive direction. More specifically, a unit height is used as a standard, and a bead that is subsequently formed may be determined based on whether the height exceeds the standard. At this time, in the case where there are multiple candidates, the formation order may be further adjusted based on the condition described above. The predetermined unit height described above may be determined based on, for example, the height of the unit size that is used when the mesh division is performed.

[Process Flow]

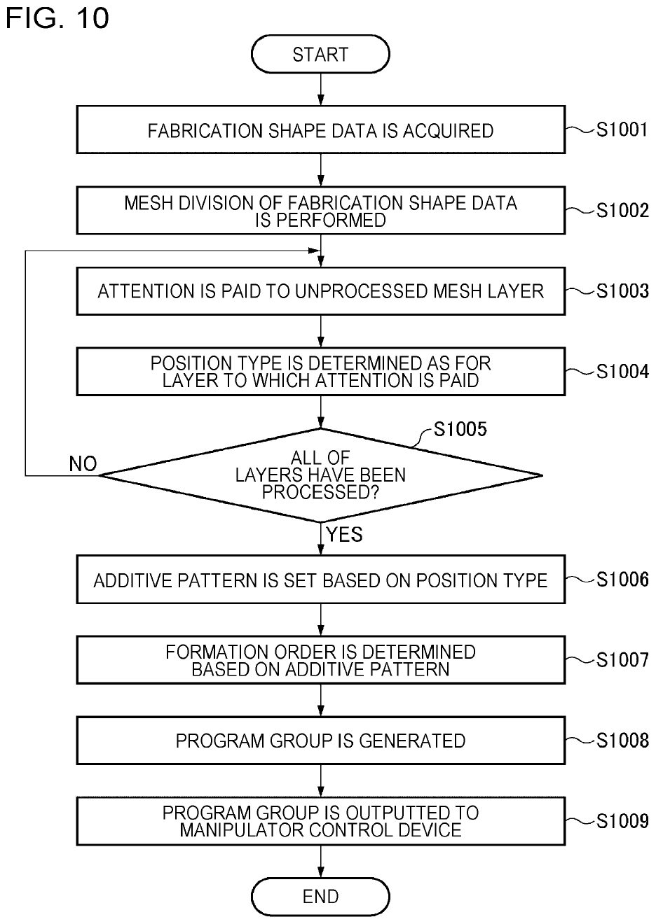

FIG. 10 is a flowchart of processing according to the present embodiment. The processing may be performed, for example, in a manner in which the control unit such as the CPU or the GPU that is included in the fabrication control device 2 reads and runs the program from the storage device, not illustrated, for causing the components illustrated in FIG. 2 to function. In the description herein, a subject that performs the processing is the fabrication control device 2 to make the description easy to understand.

At S1001, the fabrication control device 2 acquires the fabrication shape data of the additive fabrication object W to be fabricated. The fabrication shape data may be acquired from the outside or may be produced by using the application that is installed in the fabrication control device 2 and that is not illustrated and may be acquired as described above.

At S1002, the fabrication control device 2 performs the mesh division of the shape of the additive fabrication object W that is indicated by the fabrication shape data that is acquired at S1001 into the unit size. Here, the unit size is defined in advance and held in, for example, the storage device.

At S1003, the fabrication control device 2 pays attention to a single unprocessed layer among multiple layers of the fabrication shape data after the mesh division is performed at S1002. For example, attention may be paid to the unprocessed layer in order from the slice data of the bottom layer.

At S1004, the fabrication control device 2 determines the position type of each element for sorting as for the layer to which attention is paid. A determination method is described above with reference to FIG. 8.

At S1005, the fabrication control device 2 determines whether all of the layers have been processed. If all of the layers have been processed (YES at S1005), the process of the fabrication control device 2 proceeds to S1006. If there is an unprocessed layer (NO at S1005), the process of the fabrication control device 2 returns to S1003, and the process on the unprocessed layer is repeated.

At S1006, the fabrication control device 2 sets the additive pattern of each portion, based on the additive pattern DB 14 and the position type that is determined at S1004. A setting method at this time is described above.

At S1007, the fabrication control device 2 adjusts the formation order for the beads, based on the additive pattern that is set for each portion. An adjusting method at this time is described above.

At S1008, the fabrication control device 2 generates the program group that is used by the manipulator control device 4, based on the set additive pattern and the formation order.

At S1009, the fabrication control device 2 outputs the program group that is generated at S1008 to the manipulator control device 4. The process flow ends.

According to the present embodiment described above, the fabrication conditions such as the deposition condition and the additive pattern can be set depending on the position in the additive fabrication object. For this reason, the efficiency of the additive fabrication can be increased, and a welding failure can be inhibited from occurring.

### OTHER EMBODIMENTS

The present invention can also be carried out in a manner in which the system or an apparatus is provided with a program or application for fulfilling one or more functions according to the above embodiments via a network or a storage medium, and one or more processors of a computer of the system or the apparatus read and run the program.

The one or more functions may be fulfilled by using a circuit. Examples of the circuit that fulfills the one or more functions include an ASIC (Application Specific Integrated Circuit) and a FPGA (Field Programmable Gate Array).

The present specification discloses the following matters as described above.

(1) A method of setting a fabrication condition for performing additive fabrication of an object, based on fabrication shape data of the object includes a dividing step of dividing a shape that is indicated by using the fabrication shape data into elements that have a predetermined unit size, a sorting step of sorting the elements that form sectional shapes according to a predetermined position type as for the multiple sectional shapes in an additive direction, and a setting step of setting the fabrication condition from an additive pattern that is defined according to the position type as for regions that are sorted at the sorting step. With this feature, the efficiency of the additive fabrication can be increased, and a welding failure can be inhibited from occurring. In particular, the appropriate fabrication condition can be set depending on the position in the additive fabrication object.

(2) The method described in (1) further includes an adjusting step of adjusting the fabrication condition that is set for the sorted regions of the multiple sectional shapes. With this feature, the fabrication condition that is set depending on the position is adjusted, and consequently, more appropriate control can be implemented.

(3) In the method described in (1) or (2), the additive pattern is determined based on at least deposition condition information and formation route information. With this feature, the additive pattern can be determined depending on the route or the deposition condition for forming a bead.

(4) In the method described in (3), the deposition condition information includes deposition process information that is determined based on at least a bead height or a bead width. With this feature, the additive pattern can be determined by using the deposition process information that is determined based on at least the bead height or the bead width.

(5) In the method described in (4), the deposition process information includes a condition of information related to a heat source direction, an amount of heat input, and a deposition rate. With this feature, the additive pattern can be determined by using information based on data that indicates the bead shape, that is, the deposition process information that includes the information about the deposition rate, the information about the amount of heat input, and the information about the heat source direction.

(6) In the method described in any one of (1) to (5), the position type includes at least two or more portions among an inclined portion, a curved portion, an outer edge portion, an infill portion, and a flat portion. With this feature, the appropriate fabrication condition can be set for the flat portion, the curved portion, the outer edge portion, the infill portion, and the inclined portion as the position type.

(7) In the method described in any one of (1) to (6), a bead height that is represented by using the additive pattern matches a height of the predetermined unit size. With this feature, the height when the shape that is indicated by the data is sorted is matched with the bead height, and consequently, the fabrication condition is readily set.

(8) In the method described in (1), the setting step further includes setting the fabrication condition from the additive pattern that is defined according to the position type, based on at least a bead height or width when the additive fabrication is performed. With this feature, the more appropriate fabrication condition can be set depending on the bead height and width.

(9) In the method described in (8), the position type includes at least two or more portions among an outer edge portion, an infill portion, a boundary portion that is located along a boundary between the outer edge portion and the infill portion, and a boundary portion corner that is located at a corner of the boundary portion. With this feature, the appropriate fabrication condition can be set for the outer edge portion, the infill portion, the boundary portion, and the boundary portion corner as the position type.

(10) In the method described in (8) or (9), as for the additive pattern, the bead height when the additive fabrication is performed changes depending on the position type, and the method further includes a determination step of determining a formation order for a bead when the additive fabrication is performed depending on the bead height. With this feature, the formation order for the bead can be determined according to different bead heights during the fabrication depending on the position type. Accordingly, the efficiency of the additive fabrication can be increased, and a welding failure can be inhibited from occurring depending on the position type.

(11) In the method described in any one of (8) to (10), the setting step includes setting the fabrication condition such that regions of different position types are formed along a single pass. With this feature, multiple kinds of the fabrication conditions according to multiple kinds of the position types are set, and the additive fabrication can be performed along the single pass that corresponds to a single bead.

(12) An additive fabrication method of performing additive fabrication of an object, based on fabrication shape data of the object includes a dividing step of dividing a shape that is indicated by using the fabrication shape data into elements that have a predetermined unit size, a sorting step of sorting the elements that form sectional shapes according to a predetermined position type as for the multiple sectional shapes in an additive direction, a setting step of setting a fabrication condition from an additive pattern that is defined according to the position type as for regions that are sorted at the sorting step, and a control step of causing a fabrication means to perform the additive fabrication of the object, based on the fabrication condition that is set at the setting step. With this feature, the efficiency of the additive fabrication can be increased, and a welding failure can be inhibited from occurring. In particular, the appropriate fabrication condition can be set depending on the position in the additive fabrication object.

(13) An additive fabrication system that performs additive fabrication of an object, based on fabrication shape data of the object includes an acquiring means that acquires the fabrication shape data, a storage means that associates a shape of an element that is included in the object and an additive pattern for fabricating the element with each other and that holds the shape and the additive pattern, a dividing means that divides a shape that is indicated by using the fabrication shape data into elements that have a predetermined unit size, a sorting means that sorts the elements that form sectional shapes according to a predetermined position type as for the multiple sectional shapes in an additive direction, a setting means that sets a fabrication condition from the additive pattern that is defined according to the position type as for regions that are sorted by the sorting means, and a fabrication means that performs the additive fabrication of the object, based on the fabrication condition that is set by the setting means. With this feature, the efficiency of the additive fabrication can be increased, and a welding failure can be inhibited from occurring. In particular, the appropriate fabrication condition can be set depending on the position in the additive fabrication object.

(14) A program causes a computer to execute a dividing step of dividing a shape that is indicated by using fabrication shape data of an object into elements that have a predetermined unit size, a sorting step of sorting the elements that form sectional shapes according to a predetermined position type as for the multiple sectional shapes in an additive direction, and a setting step of setting a fabrication condition for performing additive fabrication of the object from an additive pattern that is defined according to the position type as for regions that are sorted at the sorting step. With this feature, the efficiency of the additive fabrication can be increased, and a welding failure can be inhibited from occurring. In particular, the appropriate fabrication condition can be set depending on the position in the additive fabrication object.

The embodiments are described above with reference to the drawings. However, it goes without saying that the present invention is not limited to the embodiments. It is clear for a person skilled in the art to conceive various modifications and alterations within the range of claims, and these are naturally included in the technical range of the present invention. The features according to the embodiments described above may be freely combined without departing from the spirit of the invention.

This application claims the benefit of Japanese Patent Application No. 2020-161261 filed Sep. 25, 2020, which is hereby incorporated by reference herein in their entirety.

### REFERENCE SIGNS LIST

1 . . . additive fabrication system
2 . . . fabrication control device
3 . . . manipulator
4 . . . manipulator control device
5 . . . controller
6 . . . heat source control device
7 . . . base
8 . . . torch
10 . . . input unit
11 . . . storage unit
12 . . . fabrication shape data
13 . . . position type DB (database)
14 . . . additive pattern DB (database)
15 . . . division unit
16 . . . position-type-determining unit
17 . . . additive-pattern-setting unit
18 . . . fabrication-condition-adjusting unit
19 . . . program-generating unit
20 . . . output unit
51 . . . mesh division unit
52 . . . formation-order-adjusting unit
W . . . additive fabrication object

1. A method of setting a fabrication condition for performing additive fabrication of an object, based on fabrication shape data of the object, the method comprising:
a dividing step of dividing a shape that is indicated by using the fabrication shape data into elements that have a predetermined unit size;
a sorting step of sorting the elements that form sectional shapes according to a predetermined position type as for the multiple sectional shapes in an additive direction; and
a setting step of setting the fabrication condition from an additive pattern that is defined according to the position type as for regions that are sorted at the sorting step.

2. The method according to claim 1, further comprising: an adjusting step of adjusting the fabrication condition that is set for the sorted regions of the multiple sectional shapes.

3. The method according to claim 1, wherein the additive pattern is determined based on at least deposition condition information and formation route information.

4. The method according to claim 3, wherein the deposition condition information includes deposition process information that is determined based on at least a bead height or a bead width.

5. The method according to claim 4, wherein the deposition process information includes a condition of information related to a heat source direction, an amount of heat input, and a deposition rate.

6. The method according to claim 1, wherein the position type includes at least two or more portions among an inclined portion, a curved portion, an outer edge portion, an infill portion, and a flat portion.

7. The method according to claim 1, wherein a bead height that is represented by using the additive pattern matches a height of the predetermined unit size.

8. The method according to claim 6, wherein a bead height that is represented by using the additive pattern matches a height of the predetermined unit size.

9. The method according to claim 1, wherein the setting step further includes setting the fabrication condition from the additive pattern that is defined according to the position type, based on at least a bead height or width when the additive fabrication is performed.

10. The method according to claim 9, wherein the position type includes at least two or more portions among an outer edge portion, an infill portion, a boundary portion that is located along a boundary between the outer edge portion and the infill portion, and a boundary portion corner that is located at a corner of the boundary portion.

11. The method according to claim 9, wherein as for the additive pattern, the bead height when the additive fabrication is performed changes depending on the position type, and
wherein the method further includes a determination step of determining a formation order for a bead when the additive fabrication is performed depending on the bead height.

12. The method according to claim 9, wherein the setting step includes setting the fabrication condition such that regions of different position types are formed along a single pass.

13. The method according to claim 11, wherein the setting step includes setting the fabrication condition such that regions of different position types are formed along a single pass.

14. An additive fabrication method of performing additive fabrication of an object, based on fabrication shape data of the object, the method comprising:
a dividing step of dividing a shape that is indicated by using the fabrication shape data into elements that have a predetermined unit size;
a sorting step of sorting the elements that form sectional shapes according to a predetermined position type as for the multiple sectional shapes in an additive direction;
a setting step of setting a fabrication condition from an additive pattern that is defined according to the position type as for regions that are sorted at the sorting step; and
a control step of causing a fabrication means to perform the additive fabrication of the object, based on the fabrication condition that is set at the setting step.

15. An additive fabrication system that performs additive fabrication of an object, based on fabrication shape data of the object, the additive fabrication system comprising:
an acquiring means that acquires the fabrication shape data;
a storage means that associates a shape of an element that is included in the object and an additive pattern for fabricating the element with each other and that holds the shape and the additive pattern;
a dividing means that divides a shape that is indicated by using the fabrication shape data into elements that have a predetermined unit size;
a sorting means that sorts the elements that form sectional shapes according to a predetermined position type as for the multiple sectional shapes in an additive direction;
a setting means that sets a fabrication condition from the additive pattern that is defined according to the position type as for regions that are sorted by the sorting means; and
a fabrication means that performs the additive fabrication of the object, based on the fabrication condition that is set by the setting means.

16. A program for causing a computer to execute:
a dividing step of dividing a shape that is indicated by using fabrication shape data of an object into elements that have a predetermined unit size;
a sorting step of sorting the elements that form sectional shapes according to a predetermined position type as for the multiple sectional shapes in an additive direction; and
a setting step of setting a fabrication condition for performing additive fabrication of the object from an additive pattern that is defined according to the position type as for regions that are sorted at the sorting step.
